(19) United States
(12) Patent Application Publication
(10) Pub. No.: US 2010/0164880 A1
(43) Pub. Date: Jul. 1, 2010

(54) Method of converting touch pad into touch mode or number-key and/or hot-key input mode

(75) Inventors: Li-Chun Huang, Zhonghe City (TW); Yen-Chun Wu, Shulin City (TW)

Correspondence Address: BACON & THOMAS, PLLC, 625 SLATERS LANE, FOURTH FLOOR, ALEXANDRIA, VA, 22314-1176, US

(73) Assignee: ORtek Technology,Inc., Chung Ho City (TW)

(21) Appl. No.: 12/458,748

(22) Filed: Jul. 22, 2009

(30) Foreign Application Priority Data
Dec. 30, 2008 (TW) 097151334

(51) Int. Cl. G06F 3/041

(52) U.S. Cl. 345/173

(57) ABSTRACT

The present invention is to provide a method for converting a touch pad into a touch mode or a number-key and/or hot-key input mode, which is applicable to a touch pad including a main control unit and at least one mode conversion key. The main control unit automatically turns on the touch pad and brings the touch pad into the touch mode. After the at least one mode conversion key is pressed, the main control unit converts the touch pad into the number-key and/or hot-key input mode. At this time, each position on the touch pad is defined by a set of absolute coordinates. The plural sets of absolute coordinates correspond respectively to a plurality of arrayed number and/or function blocks each having a unique key code value, thus allowing the touch pad to be used as a keyboard for inputting numbers and/or providing hot-key functions.

### FIELD OF THE INVENTION

The present invention relates to a touch pad, more particularly to a method for converting a touch pad into a number-key and/or hot-key input mode by defining each position on the touch pad as a set of absolute coordinates, which correspond respectively to a plurality of arrayed number and/or function blocks each having a unique key code value, so as to allow a user to use the touch pad as a keyboard for inputting numbers and/or providing hot-key functions.

### BACKGROUND OF THE INVENTION

With the improvement of people's living standard and the increase in consumer purchasing power, more and more electronic devices (e.g., notebook computers) are added with increasingly convenient functions. It is hoped that, by lowering the complexity of operation, users are allowed to learn speedily how to operate the electronic devices. One notable example of such electronic devices is the touch pad, which is now widely used. Generally, a touch pad is an input device on which a finger or stylus can slide so as to control the movement of a cursor by changing the sliding direction of the finger or stylus. Recently, more advanced operational functions were developed for touch pads to enable users to start/end programs, change the size of a display window, or flip photos by means of multiple finger movements. Due to their convenience, touch pads gradually become an important feature to look for when buying computers.

Traditional touch pads can be classified, according to their overall structure and the sensing principles involved, into resistive touch pads, capacitive touch pads, wave-based (e.g., acoustic wave-based) touch pads, optical (e.g., infrared-based) touch pads, and so on. These touch pads are configured to perform a computing process on a detected response (e.g., voltage variation, capacitance variation, etc.) and then determine the positions where the touch pads are being touched by a user's fingers. Further, the touch pads can calculate the distance and direction of finger displacements according to relative coordinates, thereby realizing touch control. As described above, there are various technically mature sensing methods for use by touch pads. Manufacturers can use touch pads of different sensing methods to suit the needs of specific products. As touch pads are very thin and basically do not work on mechanical principles, the volume and thickness of an electronic product will not be increased when equipped with a touch pad. Moreover, the maintenance of touch pads is also very convenient. Consequently, more and more electronic products are provided with touch pads as a standard feature.

One major function of the touch pad is to replace the mouse. Some users would additionally connect a touch pad to a computer and use the touch pad as a mouse. On the other hand, some manufacturers integrate a keyboard device and a touch pad into a one-piece unit so that a user need not use a mouse after connecting the integrated keyboard device to a computer, and in consequence the use of space becomes more efficient. The integration of a keyboard device with a touch pad is common in notebook computers so as to meet the trend of miniaturization. However, such integrated keyboard devices require complicated operation. Referring now to FIGS. 1 and 2, a keyboard device 1 includes a main keyboard area 11 and a touch pad 13. (For the sake of simplicity, only certain symbols in the main keyboard area 11 are shown in FIG. 2.) The keyboard device 1 is provided with a control unit 10. After the keyboard device 1 is connected to a computer 2, the control unit 10 can transmit the key code values of keys pressed by a user or sensing results obtained from the touch pad 13 to the computer 2. In order to effectively reduce the volume of the keyboard device 1, the keyboard device 1 is not provided with a number and calculation area typical of a traditional keyboard device. When it is desired to input numbers into an application program of the computer 2, the user must press keys 111 located in the second row of the main keyboard area 11 and labeled with solid-line number symbols, so as for the keyboard device 1 to transmit to the computer 2 the key code values corresponding to the numbers labeled on the pressed keys 111. However, as the keys 111 labeled with the solid-line number symbols are arranged in a horizontal row, which is different from the arrangement of number keys in the number and calculation area of a traditional calculator or keyboard device, it is inconvenient to operate the keys 111. In addition, if a user using a Chinese or Japanese input method for inputting data into the computer 2 presses the keys 111 labeled with solid-line number symbols, the computer 2 will determine the key code values transmitted from the keyboard device 1 as corresponding Chinese or Japanese phonetic symbols and then show the Chinese or Japanese phonetic symbols, rather than the number symbols, on a display device of the computer 2. The keys 111 cannot be used to input numbers until the user switches the input method mode. Then, if it is desired to input Chinese or Japanese characters again, the input method mode must be switched back to the originally used Chinese or Japanese input method. The foregoing operation undoubtedly causes much trouble to the user. To solve the problem, a number-lock key 113 is added to the keyboard device 1, and certain keys are additionally labeled with number symbols enclosed by solid circles. For clearly describing the operation of such a keyboard device 1, the keys 111 labeled only with solid-line symbols are defined as first keys 111, and the keys labeled with both solid-line symbols and symbols enclosed by solid circles are defined as second keys 115. When the number-lock key 113 is deactivated, the first keys 111 and the second keys 115 of the main keyboard area 11 transmit key code values corresponding to the solid-line symbols to the control unit 10. For example, when a first key 111 labeled with the solid-line symbol “U” is pressed, the keyboard device 1 transmits a key code value corresponding to “U” to the computer 2. However, when the number-lock key 113 is activated, the second keys 115 of the main keyboard area 11 will be converted into a number-key mode (i.e., corresponding to the symbols enclosed by solid circles, as shown in FIG. 2). At the meantime, the number-lock key status of the computer 2 is switched to an activated status. Therefore, when a second key 115 labeled with the solid-line symbol “U” is pressed, the computer 2 will determine the key code value transmitted from the keyboard device 1 as the number “4”. Thus, by switching the number-lock key 113, numbers can be input in a way similar to the conventional way.

However, referring back to FIG. 2, while the foregoing operation allows a user to input numbers in almost the conventional way, there is still a problem when the user has to input English letters and numbers alternately with the keyboard device 1. More specifically, the user must switch the status of the number-lock key 113 of the main keyboard area 11 to the activated status for inputting numbers and, after the numbers are input, switch the status of the number-lock key 113 of the main keyboard area 11 back to the deactivated status so as to input English letters in a normal manner. For the user, the above operation of the keyboard device 1 is complicated and inconvenient. Therefore, it is important for designers of touch pads and keyboard devices to figure out a method for controlling a touch pad so as to solve the aforesaid problems, provide a more user-friendly operation mode without introducing additional elements, and increase consumers' liking for the products.

In view of the various shortcomings of the conventional touch pads when used with keyboard devices, particularly the inconvenience of operation, the inventor of the present invention put much effort in research and experiment and finally succeeded in developing a method for converting a touch pad into a touch mode or a number-key and/or hot-key input mode. It is hoped that, with the present invention, related manufacturers can provide consumers with a more convenient way to control touch pads.

### BRIEF SUMMARY OF THE INVENTION

One objective of the present invention is to provide a method for converting a touch pad into a touch mode or a number-key and/or hot-key input mode, wherein the method is applicable to a touch pad including a main control unit and at least one mode conversion key. According to the method, the main control unit automatically turns on the touch pad and brings the touch pad into the touch mode. Then, after the at least one mode conversion key is pressed, the main control unit converts the touch pad into the number-key and/or hot-key input mode. At this time, each position on the touch pad is defined by a set of absolute coordinates. The plural sets of absolute coordinates correspond respectively to a plurality of arrayed number and/or function blocks, and each of the number and/or function blocks has a unique key code value, thus allowing the touch pad to be used as a keyboard for inputting numbers and/or providing hot-key functions. Hence, manufacturers can furnish the touch pad with multiple functions such as a touch function, a number input function, and a hot-key input function, thereby effectively enhancing the performance and convenience of the touch pad.

Another objective of the present invention is to provide a method for converting a touch pad into a touch mode or a number-key and/or hot-key input mode, wherein the touch pad and a keyboard device are integrated into one piece such that, by converting the operation mode of the touch pad, the touch pad can simulate the numeric keypad of a traditional keyboard device or a function area with a plurality of hot-key functions, thereby achieving operational convenience. The keyboard device is connected to a computer and provided with a main control unit, a main keyboard area, the touch pad, and at least one mode conversion key. The main control unit is connected to related internal electronic elements of the keyboard device and configured for transmitting input signals from the main keyboard area and the touch pad to the computer. According to the method, when the keyboard device receives electric power, the main control unit automatically turns on the touch pad and brings the touch pad into the touch mode. When the touch pad is pressed (e.g., by a finger) in the touch mode, the main control unit receives and determines various sensing results such as pressed positions, displacements, and moving directions. After the at least one mode conversion key is pressed, the mode conversion key transmits a conversion command to the main control unit. Upon receiving the conversion command, the main control unit converts the touch pad into the number-key and/or hot-key input mode. At this time, the touch pad is defined as a plurality of arrayed number and/or function blocks, wherein each of the number and/or function blocks has a unique key code value. Thus, manufacturers can provide the keyboard device with multiple functions such as the functions of a touch pad, a numeric keypad, and a hot-key keyboard, without increasing the volume of the keyboard device, thereby enhancing convenience of operation.

Yet another objective of the present invention is to provide a method for converting a touch pad into a touch mode or a number-key and/or hot-key input mode such that, when the touch pad is in a number-key mode, the present status of a number-lock key of a main keyboard area affects number and calculation blocks of the touch pad. Therefore, when a main control unit detects that the touch pad is pressed, the main control unit firstly determines whether or not the number-lock key of the main keyboard area is activated. If yes, the key code value corresponding to the pressed number and calculation block will be directly transmitted to a computer; if not, a number-lock key signal is transmitted to the computer for converting the number-lock key status of the computer into a ready-to-receive status, then the key code value corresponding to the pressed number and calculation block is transmitted to the computer, and finally another number-lock key signal is transmitted to the computer for restoring the number-lock key status of the computer to the original status, thus allowing normal operation of the main keyboard area. Therefore, when it is necessary to input English letters and numbers alternately with the keyboard device, a user does not need to switch the number-lock key repeatedly or worry if the status of the number-lock key of the main keyboard area will cause any abnormal input operation of the touch pad.

### BRIEF DESCRIPTION OF THE SEVERAL VIEWS OF THE DRAWINGS

The structure and the technical means adopted by the present invention to achieve the above and other objectives can be best understood by referring to the following detailed description of the preferred embodiments and the accompanying drawings, wherein:

FIG. 1 is a block diagram of the hardware structure of a traditional keyboard device having a touch pad;

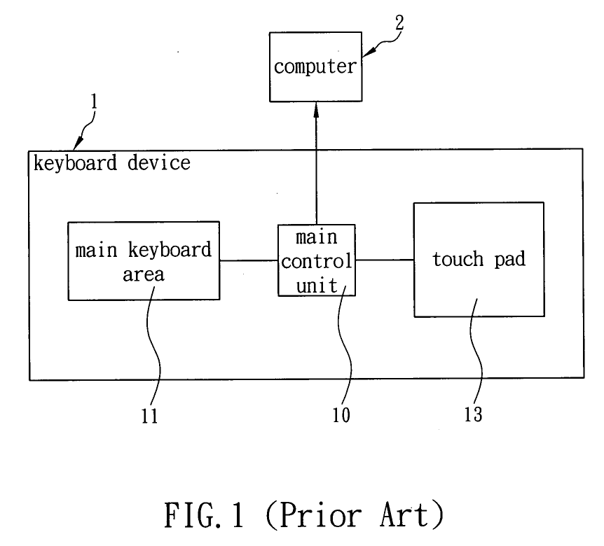

FIG. 2 is a schematic view of the traditional keyboard device having the touch pad;

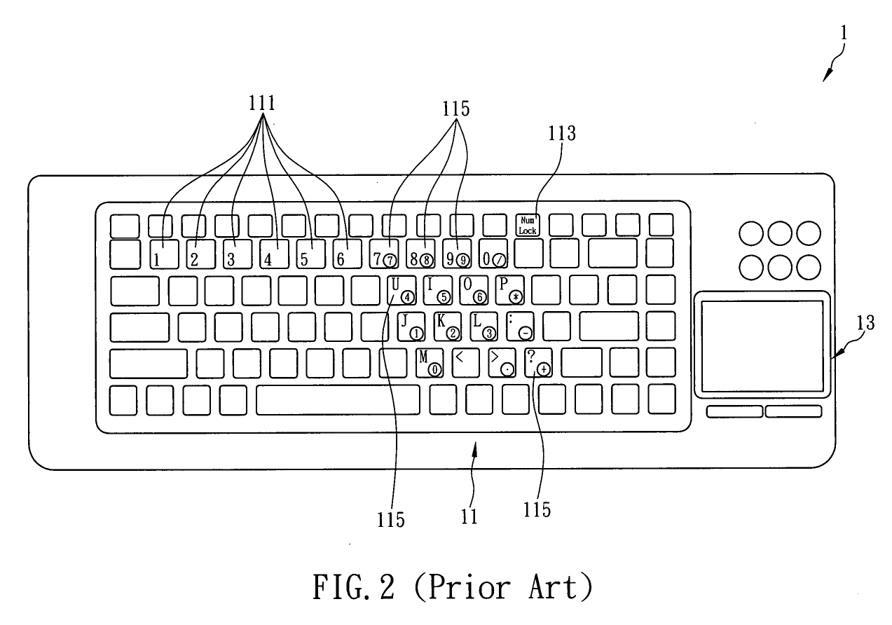

FIG. 3 is a block diagram of the hardware structure of a keyboard device having a touch pad according to the present invention;

FIG. 4 is a schematic view of the keyboard device having the touch pad according to the present invention;

FIG. 5 is a schematic view of number and calculation blocks of the touch pad, along with their respective absolute coordinates, according to the present invention;

FIG. 6 is a flowchart of a method according to one preferred embodiment of the present invention; and

FIG. 7 is a schematic view of a keyboard device according to another preferred embodiment of the present invention.

### DETAILED DESCRIPTION OF THE INVENTION

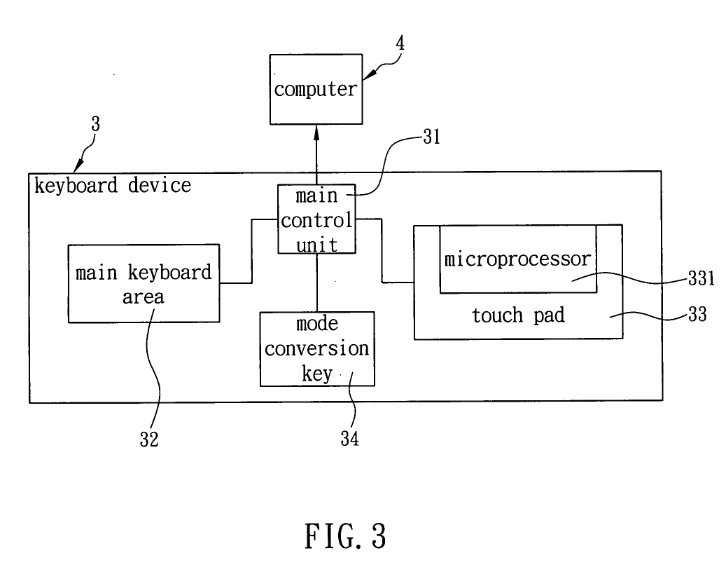

The present invention relates to a method for converting a touch pad into a touch mode or a number-key and/or hot-key input mode, and the method is applicable to a touch pad. In one preferred embodiment of the present invention, a touch pad installed on a keyboard device is exemplified. Referring to FIG. 3, a keyboard device 3 is connected to a computer 4, wherein the computer 4 is a notebook computer, and the keyboard device 3 is directly installed on the computer 4 so as to form a one-piece unit. Alternatively, the computer 4 can also be a personal computer host or a notebook computer while the keyboard device 3 is an independent device connected to the computer 4 via a connection port (e.g., an universal serial bus (USB) connection port) or via a wireless transmission means. Thus, in other embodiments of the present invention, the external configuration of the keyboard device 3 and the connection means for connecting the keyboard device 3 to the computer 4 may vary without limitation.

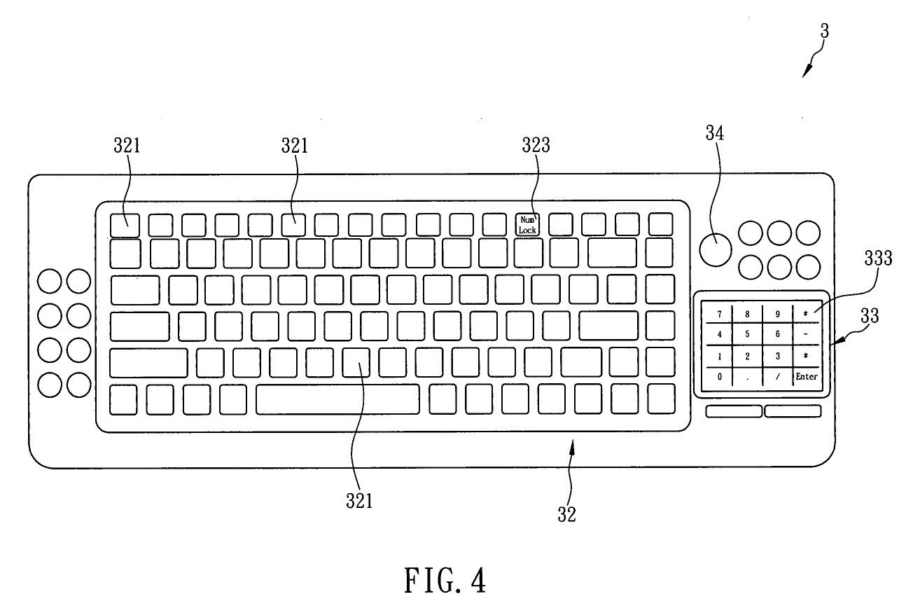

Referring now to FIGS. 3 and 4, the keyboard device 3 includes a main control unit 31, a main keyboard area 32, a touch pad 33, and at least one mode conversion key 34. The main control unit 31 is connected to related internal electronic elements of the keyboard device 3 so as for the keyboard device 3 to operate normally and transmit input signals from the main keyboard area 32 and the touch pad 33 to the computer 4. The main keyboard area 32 is provided with a plurality of keys 321 (e.g., the English-letter keys, the “Shift” key, the “Ctrl” key, etc. of a traditional keyboard device). When a user presses the keys 321, the main control unit 31 transmits key code values corresponding to the pressed keys 321 to the computer 4, thus allowing a display device (not shown) of the computer 4 to display the contents of the keys 321 pressed by the user. Furthermore, the touch pad 33 is provided with a microprocessor 331 configured for transmitting sensing results of the touch pad 33 to the main control unit 31. The main control unit 31 then transmits the sensing results to the computer 4 so as for the display device of the computer 4 to execute corresponding procedures.

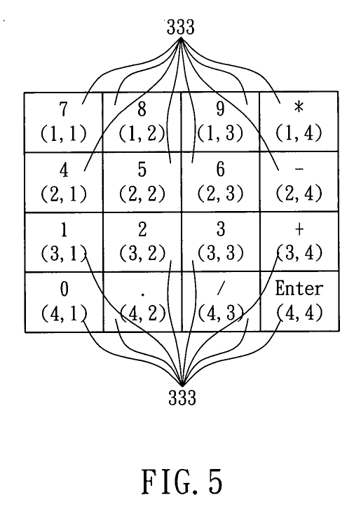

Referring back to FIG. 3, when the computer 4 is turned on, the keyboard device 3 receives electric power supplied from the computer 4. Meanwhile, the main control unit 31 commands the microprocessor 331 to turn on the touch pad 33 and bring the touch pad 33 into the touch mode. When the touch pad 33 is pressed by a finger, the microprocessor 331 detects responses at the pressed positions on the touch pad 33 and calculates the relative coordinates of the pressed positions so as to determine various sensing results such as displacements and moving directions. The sensing results are then transmitted from the microprocessor 331 to the main control unit 31, which in turn transmits the sensing results to the computer 4, thus allowing the display device of the computer 4 to execute corresponding procedures (e.g., moving a cursor, changing pages, etc.). Afterward, if it is desired to input numbers (e.g., 1, 2, 3, etc.) or calculation symbols (e.g., +, −, /, etc.) via the keyboard device 3, the user can press the mode conversion key 34 such that the mode conversion key 34 transmits a conversion command to the main control unit 31. After receiving the conversion command, the main control unit 31 transmits a mode conversion command to the microprocessor 331, commanding the microprocessor 331 to convert the touch pad 33 into a number-key mode. As a result, each position on the touch pad 33 is defined by a set of absolute coordinates. The plural sets of absolute coordinates correspond to a plurality of arrayed number and function (e.g., addition, subtraction, multiplication, and division) blocks 333, respectively. Referring to FIG. 5, in the present embodiment, the number and function block 333 labeled with “7” has the absolute coordinates of (1,1), the number and function block 333 labeled with “8” has the absolute coordinates of (1,2), the number and function block 333 labeled with “4” has the absolute coordinates of (2,1), and the number and function block 333 labeled with “1” has the absolute coordinates of (3,1). The absolute coordinates of the remaining number and function blocks 333 are defined in a similar manner. However, in other embodiments of the present invention, the number and function blocks 333 and their absolute coordinates may be arranged and defined in ways other than the above said so as to meet design needs. In addition, there are several algorithms for assigning absolute coordinates and relative coordinates to touch pads. These algorithms are well known in the art and therefore are not further explained herein.

Referring back to FIGS. 3 and 4, each of the number and function blocks 333 has a unique key code value. When the microprocessor 331 detects that the touch pad 33 is pressed (e.g., the number and function block 333 labeled with “7” is pressed), the microprocessor 331 obtains the absolute coordinates (e.g., (1,1)) of the pressed number and function block 333 and then transmits the absolute coordinates of the pressed number and function block 333 to the main control unit 31. The main control unit 31 firstly determines whether or not a number-lock key 323 of the main keyboard area 32 is activated. As the present status of the number-lock key 323 of the main keyboard area 32 is consistent with a number-lock key status of the computer 4, whenever the number-lock key 323 of the main keyboard area 32 enters an activated status or a deactivated status, the number-lock key status of the computer 4 will be changed accordingly, thus allowing the display device of the computer 4 to display a corresponding key code value. Therefore, if the number-lock key 323 of the main keyboard area 32 is in the activated status, the main control unit 31 will directly transmit the key code value corresponding to the pressed number and function block 333 to the computer 4, so that the display device of the computer 4 displays the corresponding key code value (e.g., the display device displays the number “7”). On the other hand, if the number-lock key 323 of the main keyboard area 32 is in the deactivated status, the main control unit 31 will firstly transmit a number-lock key signal to the computer 4 for converting the number-lock key status of the computer 4 into the activated status, then transmit the key code value corresponding to the pressed number and function block 333 to the computer 4, and finally transmit another number-lock key signal to the computer 4 for restoring the number-lock key status of the computer 4 to the original status (i.e., the deactivated status). Hence, when the user thereafter presses the keys 321 of the main keyboard area 32, the computer 4 will not mistakenly determine the key code value intended to be input, say “U”, as the key code value “4” due to the status change of the number-lock key 323, thereby ensuring that the main keyboard area 32 works in the original operation mode.

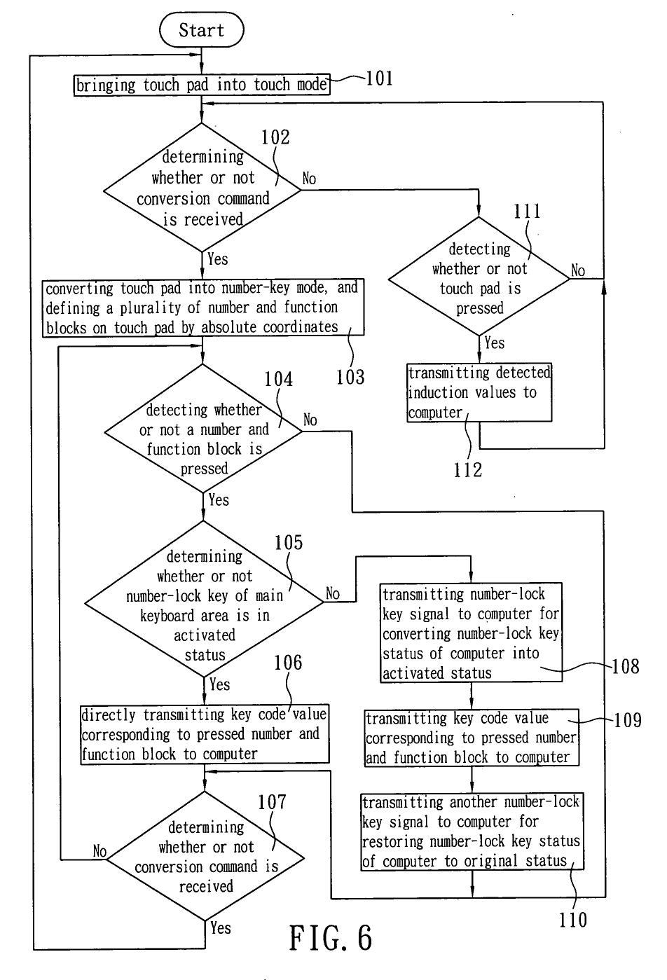

In addition, with the advancement of high-tech industry, it is possible for manufacturers to integrate the main control unit 31 and the microprocessor 331 into one piece. To clearly describe the implementation steps of the present invention, the steps for implementing the method of the present invention are detailed as follows. Referring now to FIGS. 3, 4, and 6, when the keyboard device 3 receives electric power, the main control unit 31 executes the following steps.

In step (101), the main control unit 31 brings the touch pad 33 into the touch mode, and the process goes on to step (102).

In step (102), the main control unit 31 determines whether or not a conversion command is received. If yes, the process goes on to step (103); if not, the process goes to step (111).

In step (103), the main control unit 31 converts the touch pad 33 into a number-key mode and defines a plurality of number and function blocks 333 on the touch pad 33 by means of absolute coordinates, and the process goes on to step (104).

In step (104), the main control unit 31 detects whether or not one of the number and function blocks 333 is pressed. If yes, the process goes on to step (105); if not, the process goes to step (107).

In step (105), the main control unit 31 determines whether or not the number-lock key 323 of the main keyboard area 32 is in the activated status. If yes, the process goes on to step (106); if not, the process goes to step (108).

In step (106), the main control unit 31 directly transmits a key code value corresponding to the pressed number and function block 333 to the computer 4, and the process goes on to step (107).

In step (107), the main control unit 31 determines whether or not the conversion command is received. If yes, the process returns to step (101); if not, the process returns to step (104).

In step (108), the main control unit 31 transmits a number-lock key signal to the computer 4 for converting the number-lock key status of the computer 4 into the activated status, and the process goes on to step (109).

In step (109), the main control unit 31 transmits the key code value corresponding to the pressed number and function block 333 to the computer 4, and the process goes on to step (110).

In step (110), the main control unit 31 transmits another number-lock key signal to the computer 4 for restoring the number-lock key status of the computer 4 to the original status, and the process returns to step (107).

In step (111), the main control unit 31 detects whether or not the touch pad 33 is pressed. If yes, the process goes on to step (112); if not, the process returns to step (102).

In step (112), the main control unit 31 transmits a detected sensing result to the computer 4, and the process goes back to step (102).

Therefore, a user can convert the touch pad 33 into different modes as appropriate by means of the mode conversion key 34. Furthermore, referring to FIGS. 3 and 4, in another preferred embodiment of the present invention, manufacturers may modify the steps in the foregoing flowchart according to design needs. For example, when the keyboard device 3 receives electric power, the main control unit 31 may automatically turn on the touch pad 33 and directly bring the touch pad 33 into the number-key mode, such that a plurality of arrayed number and function blocks 333 are defined on the touch pad 33 by means of absolute coordinates, wherein each of the number and function blocks 333 has a key code value. Thereafter, the touch pad 33 follows steps (104) to (110) and operates in the number-key mode. When the main control unit 31 subsequently receives a conversion signal from the mode conversion key 34, the main control unit 31 converts the touch pad 33 into the touch mode. As a result, the touch pad 33 operates in the touch mode according to steps (111) and (112), until the user makes another mode conversion.

Nowadays, most people use computers not only as a document editing tool, but also as an entertainment tool (e.g., for surfing the Internet, watching movies, etc.). Therefore, the operational steps of computers must be reduced so as for seniors and children alike to use computers with ease. To this end, the so-called hot keys were developed. By pressing the hot keys, a computer is triggered to execute preset operations (e.g., accessing a homepage, opening a video program, or executing an office software program such as Word, Excel, etc.) without the user having to painstakingly search for the desired program on the screen. Hence, in the method of the present invention, the number-key mode in the foregoing embodiment can be replaced by a hot-key mode. More specifically, all the number and function blocks 333 can be replaced by function blocks, so that a desired function can be activated simply by pressing one of the function blocks. Alternatively, it is feasible for manufacturers to combine the number-key mode with the hot-key mode. In that case, the number and function blocks 333 and the function blocks configured for use as hot keys may coexist in the same interface so as to enhance convenience of operation. As described above, without having to increase the volume of the keyboard device, the method of the present invention allows the touch pad of a keyboard device to be converted into the touch mode or the number-key and/or hot-key input mode, such that the keyboard device selectively provides the functions of a touch pad, a numeric keypad, and a hot-key keyboard. The mode of the touch pad can be converted according to the user's input needs, thereby enhancing the convenience of operation. By contrast, in the case of a traditional keyboard device, the user must switch the number-lock key repeatedly in order to input English letters and numbers alternately. In other words, the method of the present invention substantially lowers operational complexity.

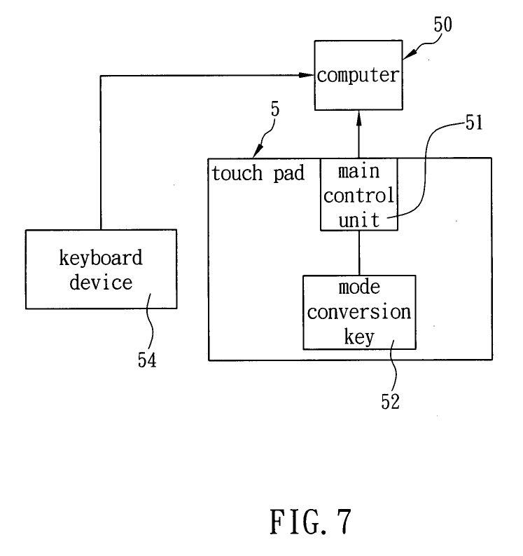

Besides, in another preferred embodiment of the present invention, the touch pad is designed as an independent element. Referring to FIG. 7, in one preferred embodiment of the present invention, a touch pad 5 is an independent element connected to a computer 50. The touch pad 5 includes a main control unit 51 and at least one mode conversion key 52. According to the method of the present invention, the main control unit 51 automatically turns on the touch pad 5 and then brings the touch pad 5 into the touch mode. After the mode conversion key 52 is pressed, the mode conversion key 52 transmits a conversion signal to the main control unit 51, so that the main control unit 51 converts the touch pad 5 into the number-key mode. Consequently, each position on the touch pad 5 is defined by a set of absolute coordinates, and the plural sets of absolute coordinates correspond to a plurality of arrayed number and function blocks, respectively, wherein each of the number and function blocks has a unique key code value. When one of the number and function blocks is pressed, the main control unit 51 transmits the key code value corresponding to the pressed number and function block to the computer 50. Thus, the touch pad 5 is used as a keyboard for inputting numbers. On the other hand, when the mode conversion key 52 is pressed once more, the mode conversion key 52 transmits the conversion signal to the main control unit 51 again. As a result, the main control unit 51 converts the touch pad 5 into the hot-key input mode. At the meantime, each position on the touch pad 5 is defined by a set of absolute coordinates, wherein the plural sets of absolute coordinates correspond to a plurality of arrayed function (e.g., linking quickly to the Internet, starting an office software program, etc.) blocks, respectively, and each of the function blocks has a unique key code value. The main control unit 51 transmits the key code value corresponding to a pressed function block to the computer 50, so that the touch pad 5 serves as a hot-key keyboard. Consequently, manufacturers can provide the touch pad 5 with multiple functions such as a touch function and a number and/or hot-key input function, in the absence of a numeric keypad and a hot-key keyboard, thereby effectively enhancing the performance and operational convenience of the touch pad 5.

In the present embodiment, when the mode conversion key 52 is pressed repeatedly, the touch pad 5 is converted from the touch mode sequentially into the number-key mode, the hot-key mode, and then back into the touch mode. However, in other embodiments of the present invention, the mode conversion sequence may differ from the above said so as to meet manufacturers' design needs. It is also possible to provide a mode conversion key for each mode such that, when one of the mode conversion keys is pressed, the touch pad is converted into the corresponding mode, thereby expanding the industrial applicability of the present invention. Furthermore, the number and function blocks may be integrated with the function blocks configured for use as hot keys, thus providing a number-key and hot-key input mode. Hence, a person skilled in the art should be able to make use of the major technical features of the present invention and modify the mode conversion sequence and the functions of the pressing blocks. In other words, the application of the present invention is limited neither to the foregoing embodiments nor to the structures and element arrangements shown in the accompanying drawings. All equivalent structures which do not depart from the scope and the spirit of the present invention should be encompassed by the appended claims. Besides, the terminology used in the present application is intended only for describing the present invention and should not be construed as limitations.

In addition, referring to FIG. 7, when the computer 50 is further connected to a keyboard device 54, the status of a number-lock key of the keyboard device 54 will affect the number-lock key status of the computer 50. Therefore, after the touch pad 5 is connected to the computer 50, the main control unit 51 detects the number-lock key status of the computer 50. When the touch pad 5 is in the number-key mode (or the number-key and hot-key input mode) and is pressed by a user, the main control unit 51 will directly transmit the key code value corresponding to the pressed number and function block to the computer 50 according to the status of the number-lock key of the keyboard device 54. Alternatively, the main control unit 51 will firstly transmit a number-lock key signal to the computer 50, then transmit the key code value corresponding to the pressed number and function block to the computer 50, and finally transmit another number-lock key signal to the computer 50.

It should be noted that, while mode conversion is carried out in the foregoing embodiments by simply pressing the mode conversion key, it may be desirable in actual application to trigger mode conversion with a combination of mode conversion keys. Thus, even if a certain mode conversion key in the combination is inadvertently pressed, operation of the keyboard device will not be affected, thus sparing the user much trouble. For example, only when the “Shift” key and the mode conversion key are sequentially pressed, in that order, will mode conversion be executed, thereby minimizing the possibility of error operation. However, the combination operation of keys of the keyboard device may vary according manufacturers' design needs without limitation to the use of the “Shift” key.

While the invention has been described by means of specific embodiments, numerous modifications and variations could be made thereto by those skilled in the art without departing from the scope and spirit of the invention set forth in the claims.

What is claimed is:

1. A method for converting a touch pad into a touch mode or a number-key and/or hot-key input mode, applicable to a keyboard device having the touch pad, wherein the keyboard device is connected to a computer and comprises a main control unit, a main keyboard area, the touch pad, and at least a mode conversion key, and the main control unit is connected to related internal electronic elements of the keyboard device so as for the keyboard device to operate normally and transmit input signals from the main keyboard area and the touch pad to the computer, the method comprising steps, executed by the main control unit when the keyboard device receives electric power, of:
automatically turning on the touch pad and bringing the touch pad into the touch mode;
converting the touch pad into the number-key and/or hot-key input mode upon receiving a conversion command transmitted from the at least a mode conversion key;
defining each of a plurality of positions on the touch pad by a set of absolute coordinates, wherein the plurality of sets of absolute coordinates correspond to a plurality of arrayed number and/or function blocks, respectively, each said number and/or function block having a unique key code value; and
detecting whether or not the touch pad is pressed.

2. The method according to claim 1, further comprising: converting the touch pad from the number-key and/or hot-key input mode into the touch mode, by the main control unit, when the main control unit receives again the conversion command transmitted from the at least a mode conversion key.

3. The method according to claim 2, further comprising: determining by the main control unit whether or not a number-lock key of the main keyboard area is activated, if the main control unit detects that the touch pad is pressed while the touch pad is in a number-key mode.

4. The method according to claim 3, further comprising: directly transmitting to the computer, by the main control unit, the key code value corresponding to a said number and/or function block being pressed, if the main control unit determines that the number-lock key of the main keyboard area is activated.

5. The method according to claim 3, further comprising steps, executed by the main control unit if the main control unit determines that the number-lock key of the main keyboard area is deactivated, of:
transmitting a number-lock key signal to the computer for converting a number-lock key status of the computer into an activated status;
transmitting to the computer the key code value corresponding to a said number and/or function block being pressed; and
transmitting another number-lock key signal for restoring the computer into the original number-lock key status.

6. The method according to claim 4, further comprising: displaying, by a display device of the computer when the computer receives the key code value transmitted from the main control unit, a corresponding value.

7. The method according to claim 5, further comprising: displaying, by a display device of the computer when the computer receives the key code value transmitted from the main control unit, a corresponding value.

8. The method according to claim 6, further comprising steps, executed by the main control unit if the main control unit detects that the touch pad is pressed while the touch pad is in the touch mode, of:
determining various sensing results including pressed positions, displacements, and moving directions; and
transmitting the sensing results to the computer.

9. The method according to claim 7, further comprising steps, executed by the main control unit if the main control unit detects that the touch pad is pressed while the touch pad is in the touch mode, of:
determining various sensing results including pressed positions, displacements, and moving directions; and
transmitting the sensing results to the computer.

10. The method according to claim 8, further comprising: executing corresponding procedures, by the display device of the computer, when the computer receives the sensing results transmitted from the main control unit.

11. The method according to claim 9, further comprising: executing corresponding procedures, by the display device of the computer, when the computer receives the sensing results transmitted from the main control unit.

12. A method for converting a touch pad into a touch mode or a number-key and/or hot-key input mode, applicable to a keyboard device having the touch pad, wherein the keyboard device is connected to a computer and comprises a main control unit, a main keyboard area, and the touch pad, and the main control unit is connected to related internal electronic elements of the keyboard device so as for the keyboard device to operate normally and transmit input signals from the main keyboard area and the touch pad to the computer, the method comprising steps, executed by the main control unit when the keyboard device receives electric power, of:
automatically turning on the touch pad and bringing the touch pad into the number-key and/or hot-key input mode;
defining each of a plurality of positions on the touch pad by a set of absolute coordinates, wherein the plurality of sets of absolute coordinates correspond to a plurality of arrayed number and/or function blocks, respectively, each said number and/or function block having a unique key code value; and
detecting whether or not the touch pad is pressed.

13. The method according to claim 12, wherein the keyboard device further comprises at least a mode conversion key, and the method further comprises converting the touch pad from the number-key and/or hot-key input mode into the touch mode, by the main control unit, when the main control unit receives a conversion command transmitted from the at least a mode conversion key.

14. The method according to claim 13, further comprising: determining by the main control unit whether or not a number-lock key of the main keyboard area is activated, if the main control unit detects that the touch pad is pressed while the touch pad is in a number-key mode.

15. The method according to claim 14, further comprising: directly transmitting to the computer, by the main control unit, the key code value corresponding to a said number and/or function block being pressed, if the main control unit determines that the number-lock key of the main keyboard area is activated.

16. The method according to claim 14, further comprising steps, executed by the main control unit if the main control unit determines that the number-lock key of the main keyboard area is deactivated, of:
transmitting a number-lock key signal to the computer for converting a number-lock key status of the computer into an activated status;
transmitting to the computer the key code value corresponding to a said number and/or function block being pressed; and
transmitting another number-lock key signal for restoring the computer into the original number-lock key status.

17. The method according to claim 15, further comprising: displaying, by a display device of the computer when the computer receives the key code value transmitted from the main control unit, a corresponding value.

18. The method according to claim 16, further comprising: displaying, by a display device of the computer when the computer receives the key code value transmitted from the main control unit, a corresponding value.

19. The method according to claim 17, further comprising steps, executed by the main control unit if the main control unit detects that the touch pad is pressed while the touch pad is in the touch mode, of:
determining various sensing results including pressed positions, displacements, and moving directions; and
transmitting the sensing results to the computer.

20. The method according to claim 18, further comprising steps, executed by the main control unit if the main control unit detects that the touch pad is pressed while the touch pad is in the touch mode, of:
determining various sensing results including pressed positions, displacements, and moving directions; and
transmitting the sensing results to the computer.

21. The method according to claim 19, further comprising: executing corresponding procedures, by the display device of the computer, when the computer receives the sensing results transmitted from the main control unit.

22. The method according to claim 20, further comprising: executing corresponding procedures, by the display device of the computer, when the computer receives the sensing results transmitted from the main control unit.

23. A method for converting a touch pad into a touch mode or a number-key and/or hot-key input mode, applicable to the touch pad, wherein the touch pad comprises a main control unit and at least a mode conversion key and is connected to a computer, and the main control unit is connected to related internal electronic elements of the touch pad so as for the touch pad to operate normally and transmit input signals from the touch pad to the computer, the method comprising steps, executed by the main control unit when the touch pad receives electric power, of:
automatically turning on the touch pad and bringing the touch pad into the touch mode;
converting the touch pad into the number-key and/or hot-key input mode upon receiving a conversion command transmitted from the at least a mode conversion key;
defining each of a plurality of positions on the touch pad by a set of absolute coordinates, wherein the plurality of sets of absolute coordinates correspond to a plurality of arrayed number and/or function blocks, respectively, each said number and/or function block having a unique key code value; and
detecting whether or not the touch pad is pressed.

24. The method according to claim 23, further comprising: converting the touch pad from the number-key and/or hot-key input mode into the touch mode, by the main control unit, when the main control unit receives again the conversion command transmitted from the at least a mode conversion key.

25. The method according to claim 24, wherein the computer is further connected to a keyboard device, and the method further comprises determining by the main control unit whether or not a number-lock key of the keyboard device is activated, if the main control unit detects that the touch pad is pressed while the touch pad is in a number-key mode.

26. The method according to claim 25, further comprising: directly transmitting to the computer, by the main control unit, the key code value corresponding to a said number and/or function block being pressed, if the main control unit determines that the number-lock key of the keyboard device is activated.

27. The method according to claim 25, further comprising steps, executed by the main control unit if the main control unit determines that the number-lock key of the main keyboard area is deactivated, of:
transmitting a number-lock key signal to the computer for converting a number-lock key status of the computer into an activated status;
transmitting to the computer the key code value corresponding to a said number and/or function block being pressed; and
transmitting another number-lock key signal for restoring the computer into the original number-lock key status.

28. The method according to claim 26, further comprising: displaying, by a display device of the computer when the computer receives the key code value transmitted from the main control unit, a corresponding value.

29. The method according to claim 27, further comprising: displaying, by a display device of the computer when the computer receives the key code value transmitted from the main control unit, a corresponding value.

30. The method according to claim 28, further comprising steps, executed by the main control unit if the main control unit detects that the touch pad is pressed while the touch pad is in the touch mode, of:
determining various sensing results including pressed positions, displacements, and moving directions; and
transmitting the sensing results to the computer.

31. The method according to claim 29, further comprising steps, executed by the main control unit if the main control unit detects that the touch pad is pressed while the touch pad is in the touch mode, of:
determining various sensing results including pressed positions, displacements, and moving directions; and
transmitting the sensing results to the computer.

32. The method according to claim 30, further comprising: executing corresponding procedures, by the display device of the computer, when the computer receives the sensing results transmitted from the main control unit.

33. The method according to claim 31, further comprising: executing corresponding procedures, by the display device of the computer, when the computer receives the sensing results transmitted from the main control unit.

34. A method for converting a touch pad into a touch mode or a number-key and/or hot-key input mode, applicable to the touch pad, wherein the touch pad comprises a main control unit and is connected to a computer, and the main control unit is connected to related internal electronic elements of the touch pad so as for the touch pad to operate normally and transmit input signals from the touch pad to the computer, the method comprising steps, executed by the main control unit when the touch pad receives electric power, of:
automatically turning on the touch pad and bringing the touch pad into the number-key and/or hot-key input mode;
defining each of a plurality of positions on the touch pad by a set of absolute coordinates, wherein the plurality of sets of absolute coordinates correspond to a plurality of arrayed number and/or function blocks, respectively, each said number and/or function block having a unique key code value; and
detecting whether or not the touch pad is pressed.

35. The method according to claim 34, wherein the touch pad further comprises at least a mode conversion key, and the method further comprises converting the touch pad from the number-key and/or hot-key input mode into the touch mode, by the main control unit, when the main control unit receives a conversion command transmitted from the at least a mode conversion key.

36. The method according to claim 35, wherein the computer is further connected to a keyboard device, and the method further comprises determining by the main control unit whether or not a number-lock key of the keyboard device is activated, if the main control unit detects that the touch pad is pressed while the touch pad is in a number-key mode.

37. The method according to claim 36, further comprising: directly transmitting to the computer, by the main control unit, the key code value corresponding to a said number and/or function block being pressed, if the main control unit determines that the number-lock key of the keyboard device is activated.

38. The method according to claim 36, further comprising steps, executed by the main control unit if the main control unit determines that the number-lock key of the main keyboard area is deactivated, of:
transmitting a number-lock key signal to the computer for converting a number-lock key status of the computer into an activated status;
transmitting to the computer the key code value corresponding to a said number and/or function block being pressed; and
transmitting another number-lock key signal for restoring the computer into the original number-lock key status.

39. The method according to claim 37, further comprising: displaying, by a display device of the computer when the computer receives the key code value transmitted from the main control unit, a corresponding value.

40. The method according to claim 38, further comprising: displaying, by a display device of the computer when the computer receives the key code value transmitted from the main control unit, a corresponding value.

41. The method according to claim 39, further comprising steps, executed by the main control unit if the main control unit detects that the touch pad is pressed while the touch pad is in the touch mode, of:
determining various sensing results including pressed positions, displacements, and moving directions; and
transmitting the sensing results to the computer.

42. The method according to claim 40, further comprising steps, executed by the main control unit if the main control unit detects that the touch pad is pressed while the touch pad is in the touch mode, of:
determining various sensing results including pressed positions, displacements, and moving directions; and
transmitting the sensing results to the computer.

43. The method according to claim 41, further comprising: executing corresponding procedures, by the display device of the computer, when the computer receives the sensing results transmitted from the main control unit.

44. The method according to claim 42, further comprising: executing corresponding procedures, by the display device of the computer, when the computer receives the sensing results transmitted from the main control unit.
